(19) United States
(12) Patent Application Publication
(10) Pub. No.: US 2007/0089506 A1
(43) Pub. Date: Apr. 26, 2007

(54) Tank gauge

(76) Inventor: Bruce Paradiso, Waynesboro, VA (US)

Correspondence Address: Bryan D. Wright, Suite 400, 321 E. Main St., Charlottesville, VA, 22902, US

(21) Appl. No.: 11/546,046

(22) Filed: Oct. 11, 2006

Related U.S. Application Data
(60) Provisional application No. 60/725,973, filed on Oct. 12, 2005.

(51) Int. Cl. G01F 23/00

(52) U.S. Cl. 73/313

(57) ABSTRACT

A tank gauge for measuring the level of a liquid in a tank or other container is disclosed. The gauge comprises a float which floats on the surface of the liquid to be measured or monitored, mechanically linked to a direct drive system for indicating the level of the liquid with easily read numbered wheels. This direct drive system provides a one-to-one ratio of liquid level indication with the length of play of the chain.

### RELATED U.S. PATENT APPLICATION DATA

Applicant claims priority for this application to U.S. Provisional Application No. 60/725,973 filed on Oct. 12, 2005.

### FIELD OF THE INVENTION

The invention described herein generally relates to improved mechanical tank gauges specifically designed for constant measuring or monitoring of the level of liquid in a tank or like container.

### DESCRIPTION OF THE RELATED ART

There are numerous types of devices used to measure or monitor the level of liquids in a tank or container. Closed containers preclude the use of visual measurement techniques and must rely on electronic or mechanical devices for measurement of liquid levels.

Existing mechanical tank gauges use a string-like material or filament to connect a float to the gauge assembly. This string-like material or filament tends to fray, tangle, stretch, rot, and ultimately break, rendering the gauge useless. Further, existing mechanical gauges retract the string-like material or filament in a bobbin-like fashion whereby the string or filament is wound upon itself, increasing the diameter of the bobbin as more string is wound. This increasing diameter skews the accuracy of the measurement of the gauge. The disclosed gauge overcomes these problems by using a nickel plated brass beaded chain, also known as a ball chain, to attach the float to the gauge assembly and by providing a retraction mechanism whereby the diameter of the chain pulley, with the chain on it, remains the same when the chain is extended or retracted. The beaded chain allows the float to swivel without fraying, tangling, stretching, rotting, or breaking. Further, the disclosed tank gauge provides a direct drive grooved chain pulley which directly drives at least one numbered wheel, revealing the liquid level in the tank in a one-to-one ratio. Thus, the accuracy of the disclosed gauge remains true as the liquid level falls or rises.

Existing gauges are not generally depth adjustable, requiring distributors to stock many different gauges for use in different depth tanks. The present invention is fully adjustable to all tank depths by using the chain which can be calibrated to a tank's specific depth by the installer. Moreover, to date, there is on the market no tank gauge other than the Red Fox™ that is designed specifically to measure inches to full. Heretofore, users have found it necessary to mark tanks with a message to indicate whether they were watching it for high tank or low tank status. With the disclosed invention, a tank can be measured to full or to empty, depending on the use of the Black Knight™ or Red Fox™ gauges.

It should be noted that the disclosed tank gauge which indicates how many inches of liquid are left until the container is empty is known as the Black Knight™. The disclosed gauge which indicates how many inches remain before the container is full, is known as the Red FOX™. Both of these gauges have enjoyed considerable commercial success because of the advantages described, as well as the large numerical displays which are simple to read, the ease of attaching the disclosed gauge to a container or tank, the ease by which the gauge is calibrated to a specific tank, and its simple mechanical design with primarily non-corrosive materials.

### SUMMARY OF THE INVENTION

Generally, the Black Knight™ and Red Fox™ tank gauges are mechanical tank gauges designed for measuring the level of liquid in tanks and other containers. Incorporated into their design is a grooved chain pulley which directly drives at least one numbered wheel which indicates the liquid level in a one-to-one ratio. The grooved chain pulley is retracted by a spring which maintains tension on the ball chain connected to the weighted float which rides on top of the liquid in the storage tank.

The disclosed tank gauge is easily calibrated to the specific depth of a tank in the following manner. Once the depth of the tank is determined (for example, 67 inches), the ball chain is pulled until the display reads 67 inches (the specific tank depth). The chain is marked and another 1½ feet of chain is extended. The chain at that point is secured with an eyelet. An eyelet is a standard device used on ball chains whereby the ball onto which the eyelet is snapped is precluded from passing through a hole sized to accommodate the ball without an eyelet attached. The chain is then cut below the point at which the eyelet is attached so that the eyelet remains at the bottom of the chain. The chain is then ready to use for the specified 67 inch tank. The float is inserted through the tank bung hole and lowered to float upon the liquid level. The gauge housing is then affixed to the tank using a pipe wrench on the housing nipple. The disclosed gauge is easily attached to conventional tanks with the use of Teflon® tape or pipe sealant to the nipple threads at the base of the housing.

These and other advantages are shown in the claims below and form a part hereof. For a better understanding of this invention and its advantages, reference should be made to the figure which forms a further part hereof and to the accompanying descriptive matter in which there is described a preferred embodiment of the invention.

### BRIEF DESCRIPTION OF THE DRAWINGS

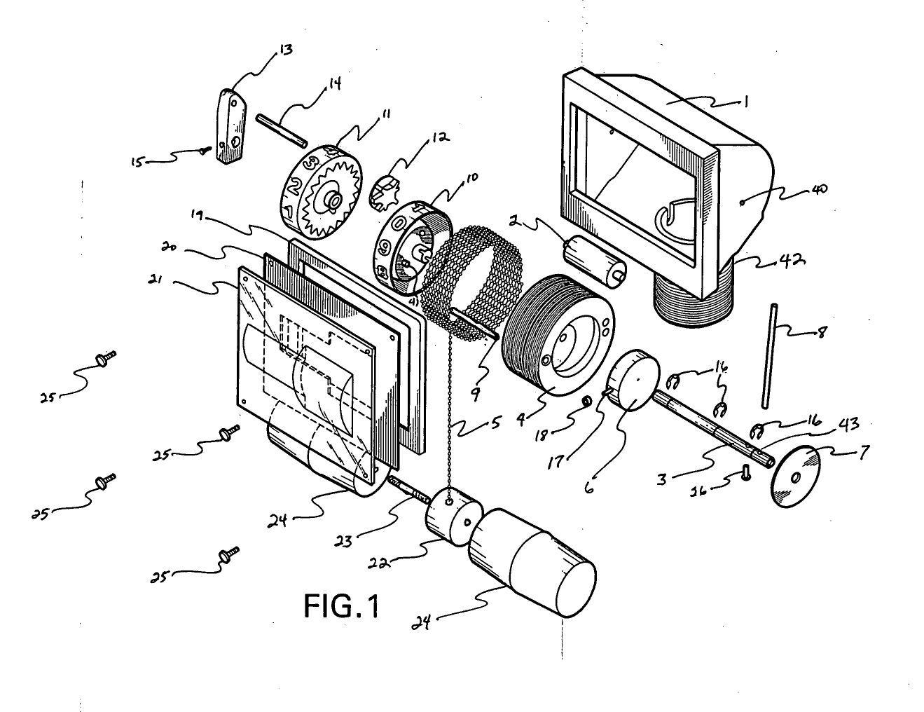

The invention will be described in detail hereunder with reference to the accompanying FIG. 1 which shows a detailed exploded view of the disclosed tank gauge.

### DETAILED DESCRIPTION OF THE INVENTION

Referring now to FIG. 1, the disclosed gauge is comprised of the following components which act together to accurately indicate the liquid level in a tank. Main shaft 3, when the gauge is fully assembled, is held in holes 40 in housing 1. Attached to main shaft 3 by shaft spring screw 26 is spring 6. Spring 6 is commonly known as a clock form spring made from flat steel. The interior end of spring 6 is attached to main shaft 3 by shaft spring screw 26. The exterior end of spring 6 is attached by spring retaining screw 17 to chain pulley 4 and secured with spring retaining nut 18. Attached to chain pulley 4 is one end of drive pin 9, the other end of which is inserted into a receiving hole 41 in numbered wheel 10, which in turn in interconnected to index gear 12 which meshes with the gear integral to numbered wheel and gear 11, whereby for each 10 turns of numbered wheel 10, numbered wheel with gear 11 moves one digit. Index gear 12 is rotatably held by index gear arm pin 14 which in turn is held by index gear arm 13, which is secured to the main shaft 3 by index gear set screw 15. Chain pulley 4, numbered wheel 10, and numbered wheel and gear 11 rotate on main shaft 3 and are held from sideways motion with e-clips 16. Spring cover 7 covers spring 6 while it is engaged with chain pulley 4. Chain 5, preferably a nickel plated brass beaded chain, also known as a ball chain, is wound in individual grooves on the radial surface of chain pulley 4. The proximal end of chain 5 is secured to chain pulley 4. Chain 5 is then wound around chain pulley 4 in an inclined plane groove such that each encirclement of chain pulley 4 by chain 5 is with the same length. Chain 5, before being attached at its distal end to float 24, is passed through nipple 42 at the bottom of casing 1. The distal end of chain 5 is adjustably attached to float 24 through a hole in weight 22 with an eyelet (not shown). Float 24 comprises two hollow parts made of plastic or other material which will not be degraded by the measured liquid or vapors therefrom. These two hollow parts are attached with threaded stud 23 which passes through weight 22 between the two hollow parts of float 24. Chain roller 2 is in frictional contact with chain pulley 4 and helps guide chain 5 into the groove on the radial surface of chain pulley 4. Tension retaining pin 8 is placed into hole 43 in main shaft 3 and prevents main shaft 3 from turning while tension from spring 6 is increased by the extension of chain 5. It should be noted that the tension of spring 6 is designed to be just sufficient to keep slack out of chain 5 as the level of liquid in the tank is lowered or raised. All components on main shaft 3 are placed within housing 1 and main shaft 3 is held by holes 40 in housing 1 at each end of main shaft 3. Covering the front of housing 1 is a front gasket 19. Covering gasket 19 is face plate 20 and clear cover 21. Cover screws 25 secure clear cover 21, face plate 20, and front gasket 19 to housing 1 for a completed unit. Gasket 19, when secured by clear cover 21 and face plate 20 with cover screws 25 keeps all components within housing 1 safe from weather and a corrosive environment.

When in use, the direct drive mechanism of the disclosed invention allows accurate monitoring of liquid levels in tanks or containers as the liquid level rises and falls. Depending on the arrangement of numbers on numbered wheel 10 and numbered wheel with gear 11, the gauge can indicate the number of inches to full or the number of inches to empty. Further, chain 5 allows full 360° rotation of float 24 at the bottom of chain 5 without the risk of tangling, kinking, or otherwise binding as chain 5 is retracted into or extended out of the tank gauge assembly. Moreover, the nickel plated brass beaded chain is resistant to deterioration, degradation, or corrosion by most fluids sought to be monitored or ambient vapors.

The advantages of the Black Knight™ and Red Fox™ tank gauges have been readily accepted by the market and have resulted from their dependable accuracy and simple mechanical design. No electronic devices are necessary.

Even though the specific details of the structure and function of the disclosed invention is presented, it is for illustration only, recognizing that slight changes may be made in the shape, size and arrangement of the parts within the disclosed invention, thus the principles of the invention to the full extent described by the broad, general meaning of the terms used in the following claims are sought to be covered by these letters patent.

While a specific embodiment of the invention has been shown and described in detail, it will be understood that the invention may be modified without departing from the spirit of the inventive principles set forth in the following claims.

What is claimed is:

1. A gauge for measuring the liquid level in a tank or container, comprising:
a housing;
a float;
a mechanical linkage attached at one end to the float;
a direct drive system attached to the other end of the mechanical linkage, further comprising:
a pulley around which the mechanical linkage is wound;
a spring to maintain tension on the mechanical linkage;
a gear system whereby the pulley directly drives at least one numbered wheel which indicates the number of inches in the tank.

2. A method for measuring or monitoring the level of a liquid in a tank or like container, comprising the steps of:
calibrating one end of a mechanical linkage to be attached to a float, with the depth of the tank;
mounting to the top of the tank a liquid level gauge which is attached to the other end of the mechanical linkage;
said liquid level gauge comprising a direct drive system whereby the retraction or extension of the mechanical linkage directly drives at least one numbered wheel to indicate the liquid level.
